(19) United States
(12) Patent Application Publication
(10) Pub. No.: US 2014/0095653 A1
(43) Pub. Date: Apr. 3, 2014

(54) Optimization Of SH Traffic By A Cache-And-Try-First Mechanism

(71) Applicants: Suzann Hua, Lisle, IL (US); Yigang Cai, Naperville, IL (US)

(72) Inventors: Suzann Hua, Lisle, IL (US); Yigang Cai, Naperville, IL (US)

(21) Appl. No.: 13/630,603

(22) Filed: Sep. 28, 2012

(51) Int. Cl. H04L 29/08

(52) U.S. Cl. CPC H04L 67/10
USPC 709/217

(57) ABSTRACT

In accordance with an exemplary embodiment, whenever an AS queries an HSS for a user's S-CSCF address, the AS stores the mobile user's S-CSCF address along with a time stamp, preferably within a database at the AS. When the AS then receives a service request requiring the use of the end user's S-CSCF address, the AS reuses the mobile user's S-CSCF address cached at the AS local database. The AS can also determine whether to reuse the user's cached S-CSCF address based on the policy of the service provider and the timestamp of the cached S-CSCF address. The AS can develop a time window for reusing the cached S-CSCF address based with policies.

### FIELD OF THE INVENTION

The present invention relates generally to communication systems.

### BACKGROUND OF THE INVENTION

IMS (IP Multimedia Subsystems) networks offer rich services, typically via a variety of Application Servers (ASs). An Sh interface typically connects a Home Subscriber Server (HSS) with the ASs.

As IMS networks becomes more ubiquitous, the usage of the Sh interfaces is significantly increased. As a result, the increased Sh message traffic significantly impacts the performance of the entire IMS network.

Therefore, a need exists for a way of continuing to offer increased services in IMS networks without overloading the network, particularly the Sh interface. In addition, any solution should preferably not impact existing network configurations.

### BRIEF SUMMARY OF THE INVENTION

An exemplary embodiment of the present invention provides a Cache And Try First (CATF) mechanism to reduce Sh interface message traffic between an Application Server (AS) and an HSS. In an exemplary embodiment, ASs, especially for those non-real time targeted ASs, do not need to always query the HSS to obtain a mobile user's S-CSCF address. Instead, an AS can first try to use the mobile user's previously used S-CSCF without querying the HSS. The AS preferably queries the HSS for the mobile user's S-CSCF address only if the attempt to determine the S-CSCF at the AS has failed.

With this new CATF mechanism, the Sh interface message traffic between the HSS and the AS is reduced, which improves the performance of the entire wireless network. It should be understood that the CATF mechanism can also be applicable to MME address or the MSC address, if an AS needs to query an HSS/HLR to find a mobile user's MME address or MSC address to deliver the service.

An exemplary embodiment of the present invention thereby provides for traffic optimization for the Sh interface between an HSS and one or more Application Servers.

### BRIEF DESCRIPTION OF THE SEVERAL VIEWS OF THE DRAWINGS

FIG. 1 depicts the functional architectural of an IMS network in accordance with an exemplary embodiment of the present invention.

FIG. 2 depicts a call flow diagram in accordance with an exemplary embodiment of the present invention.

FIG. 3 depicts a flowchart in accordance with an exemplary embodiment of the present invention.

### DETAILED DESCRIPTION OF THE INVENTION

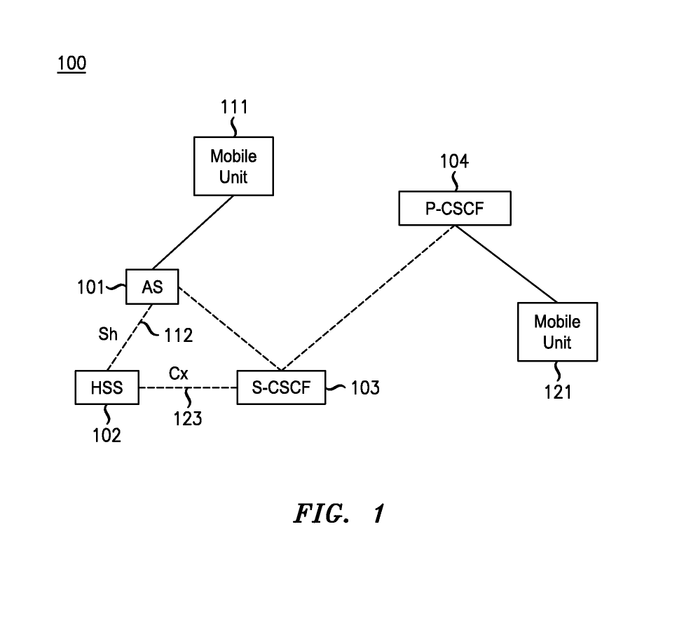

FIG. 1 depicts the functional architectural of IMS network 100. IMS network 100 preferably includes Application Server (AS) 101, Home Subscriber Server (HSS) 102, S-CSCF 103, and P-CSCF 104. Mobile unit 111 and mobile unit 121 are mobile units that can communicate with IMS network 100. In accordance with an exemplary embodiment, mobile unit 111 is attempting to place a call to mobile unit 121.

Application Server (AS) 101 is a server that provides value added services to service provider's network, for example, short message service, presence service, location service, etc. In accordance with an exemplary embodiment, AS 101 is an SMSC/AS.

In accordance with an exemplary embodiment, AS 101 includes a local database, which can be located within AS 101 or separate from AS 101. The local database caches, which stores the mobile user's S-CSCF name and SinceWhen time stamp data.

AS 101 preferably supports the following global configurable service provider policy data for the CATF feature. CATF allowed indicator data that can preferably be set to “Yes” or “No”, with the default value preferably set to “Yes”. AS 101 also preferably includes a CATF time period data field that is based on a SinceWhen time stamp. The value X of this data indicates that it has been X hours since the mobile user has registered with a S-CSCF. In accordance with an exemplary embodiment, AS 101 determines X based on policy rule sets. Policies can be per subscriber, per S-CSCF, Time of Day, Day of Week, based on network traffic, etc. In addition, the mobile user's S-CSCF address can be cached at AS 101 and can be reused for CATF in accordance with an exemplary embodiment of the present invention.

In accordance with an exemplary embodiment, whenever AS 101 receives a mobile user's S-CSCF name along with SinceWhen timestamp data, if the service provider's policy data indicates that the CATF feature is allowed, AS 101 stores the received mobile user's S-CSCF name along with the SinceWhen timestamp data.

Home Subscriber Server (HSS) 102 is a master user database that supports the IMS network entities that actually handle calls. HSS 102 preferably includes subscriber profiles and performs authentication and authorization of the user. HSS 102 can also provide information about the subscriber's location and IP information.

In accordance with an exemplary embodiment, whenever HSS 102 stores an S-CSCF name for a mobile user after receiving a Cx interface Server-Assignment-Request Diameter message from S-CSCF 103 and the message is a registration message, HSS 102 also stores time stamp data along with the S-CSCF name.

In accordance with an exemplary embodiment, whenever HSS 102 sends an S-CSCF name to AS 101 after receiving an Sh interface User-Data-Request Diameter message, HSS 101 preferably includes the time stamp data stored with the S-CSCF name in the “SinceWhen” time stamp field in a message, preferably a User-Data-Answer Diameter message.

Serving-CSCF (S-CSCF) 103 is the central node of the signaling plane. S-CSCF 103 is a SIP server that preferably also performs session control. S-CSCF 103 is preferably located in the home network and uses Diameter Cx interfaces to HSS 102 to download user profiles and upload user-to-S-CSCF associations. In an alternate exemplary embodiment, the interface 123 can be a Dx interface. All necessary subscriber profile information is preferably loaded from HSS 102. S-CSCF 103 preferably handles SIP registrations, which allows S-CSCF 103 to connect the user location, such as the IP address of the terminal, and the SIP address of the terminal. S-CSCF 103 preferably sits on the path of all signaling messages of the locally registered users, and can inspect every message. S-CSCF 103 preferably determines which application servers to forward SIP messages to. S-CSCF 103 preferably provides routing services, typically using Electronic Numbering (ENUM) lookups. It should be understood that there can be multiple S-CSCFs in network 100 for load distribution and high availability reasons.

Proxy-CSCF (P-CSCF) 104 is a SIP proxy that is preferably the first point of contact for an IMS terminal. P-CSCF 104 preferably sits on the path of all signaling messages and can inspect every signal. P-CSCF preferably provides subscriber authentication, and inspects the signaling and ensures that the IMS terminals act in accordance with network policies.

Sh 112 is an interface that interconnects AS 101 with HSS 102, and is preferably a Diameter interface. In accordance with an exemplary embodiment, new fields are added to the Sh-IMS-Data field. The new field is preferably a “since-when” time stamp data field that is to be included along with S-CSCF name. The “since-when” time stamp data field is a time stamp indicating the time since the user has registered at the S-CSCF.

Cx 123 is an interface that interconnects HSS 102 and S-CSCF 103, and is preferably a Diameter interface.

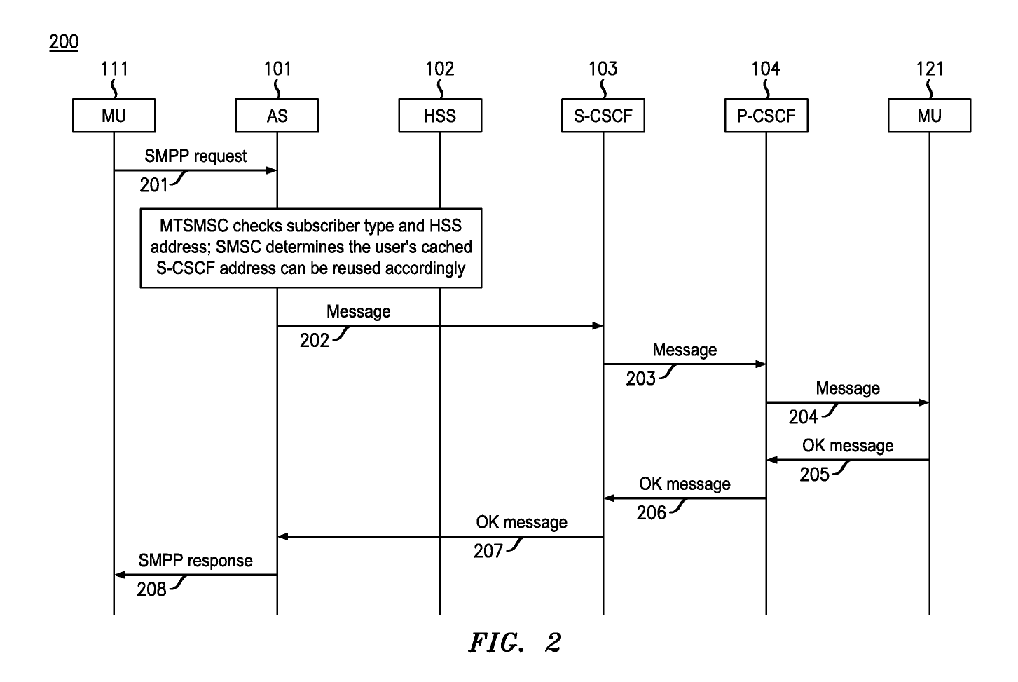

FIG. 2 depicts a call flow diagram 300 in accordance with an exemplary embodiment of the present invention. In an exemplary embodiment, Application Server 101 is an SMSC/AS.

Mobile unit (MU) 111 sends SMPP request message 201 to AS 101. SMPP request message 201 preferably includes a subscriber type field indicating MU 121.

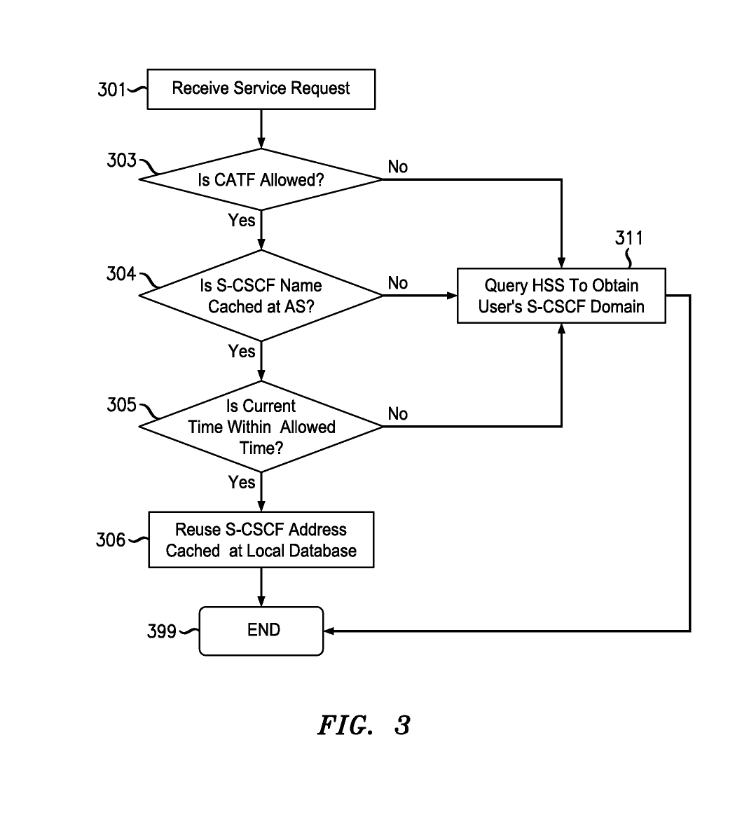

AS 101 receives SMPP message 201 and checks the subscriber type field and the HSS address. In an exemplary embodiment, AS 101 determines that the user's cached S-CSCF address can be reused, as shown in more detail in FIG. 3.

Since the S-CSCF of MU 121 is cached and can be used, AS 101 sends message 202 to S-CSCF 103, which is the cached S-CSCF.

S-CSCF 103 knows which P-CSCF is serving MU 121 and sends message 203 to that serving P-CSCF, which is P-CSCF 104 in this exemplary embodiment.

P-CSCF 104 knows the location of MU 121 and sends message 204 to MU 121.

In order to acknowledge proper receipt of message 204, MU 121 sends OK message 205 to P-CSCF 104.

P-CSCF 104 sends OK message 206 to S-CSCF 103 to alert S-CSCF 203 that the information from message 202 was sent and received properly to MU 121.

S-CSCF 103 sends OK message 207 to AS 101 to alert AS 101 that the message was delivered properly to MU 121.

AS 101 sends SMPP response message 208 to MU 111 to alert MU 111 that SMPP request 201 was properly delivered to MU 121.

FIG. 3 depicts a flowchart 300 in accordance with an exemplary embodiment of the present invention.

An AS receives (301) a service request that needs a requested end user's S-CSCF name to deliver the service.

The AS determines (303) if the CATF feature is allowed. If the CATF feature is not allowed, the AS queries (311) the HSS to obtain the user's S-CSCF domain. The process then ends (399).

If the CATF feature is allowed as determined at step 303, the AS determines (304) if the S-CSCF name for the user is stored at the AS. If not, the AS queries (311) the HSS to obtain the user's S-CSCF domain. The process then ends (399).

If the S-CSCF name is cached at the AS as determined at step 304, the AS determines (305) if the current time is within the allowed CATF time period. If not, the AS queries (311) the HSS to obtain the user's S-CSCF domain. The process then ends (399).

If the current time is within the allowed CATF time period as determine at step 305, the AS reuses (306) the S-CSCF address cached at the local database. The process then end (399).

While this invention has been described in terms of certain examples thereof, it is not intended that it be limited to the above description, but rather only to the extent set forth in the claims that follow.

We claim:

1. A method of determining which Serving Call State Control Function (S-CSCF) to route a message to, the method comprising:
receiving a request for a S-CSCF associated with a mobile unit;
determining if an S-CSCF is stored for the mobile unit;
determining whether a time associated within the S-CSCF is less than a predetermined threshold; and
reusing the stored S-CSCF for the mobile unit.

2. A method of determining which S-CSCF to route a message to in accordance with claim 1, further comprising the step of querying an HSS to obtain the S-CSCF of the end user if it is determined that an S-CSCF is not stored for the user.

3. A method of determining which S-CSCF to route a message to in accordance with claim 1, further comprising the step of querying an HSS to obtain the S-CSCF of the end user if it is determined that the time is greater than the predetermined threshold.

4. A method for storing a Serving Call State Control Function (S-CSCF) associated with a mobile unit, the method comprising:
receiving an associated S-CSCF, the associated C-CSCF being the S-CSCF that is supporting a mobile unit; and
storing the associated S-CSCF.

5. A method for storing an S-CSCF associated with a mobile unit in accordance with claim 4, further comprising the step of retrieving the associated S-CSCF.

6. A method for storing an S-CSCF associated with a mobile unit in accordance with claim 5, further comprising the step of utilizing the associated S-CSCF to connect with the mobile unit without querying a Home Subscriber Server (HSS).

7. A method for connecting to a mobile unit, the method comprising:
determining a previously used network entity associated with a mobile unit; and
utilizing the previously used network entity to connect with the mobile unit without querying an updated network entity associated with the mobile unit.

8. A method for connecting to a mobile unit in accordance with claim 7, wherein the previously used network element is a Serving Call State Control Function (S-CSCF).

9. A method for connecting to a mobile unit in accordance with claim 8, wherein the step of utilizing the previously used network entity to connect with the mobile unit without querying for an updated network entity associated with the mobile unit comprises utilizing the S-CSCF to connect with the mobile unit without querying a Home Subscriber Server (HSS).

10. A method for connecting to a mobile unit in accordance with claim 7, wherein the previously used network element is a Mobility Management Element (MME) address.

11. A method for connecting to a mobile unit in accordance with claim 10, wherein the step of utilizing the previously used network entity to connect with the mobile unit without querying for an updated network entity associated with the mobile unit comprises utilizing the MME to connect with the mobile unit without querying a Home Subscriber Server (HSS).

12. A method for connecting to a mobile unit in accordance with claim 10, wherein the step of utilizing the previously used network entity to connect with the mobile unit without querying for an updated network entity associated with the mobile unit comprises utilizing the MME to connect with the mobile unit without querying a Home Location Register (HLR).

13. A method for connecting to a mobile unit in accordance with claim 7, wherein the previously used network element is a Mobile Switching Center (MSC) address.

14. A method for connecting to a mobile unit in accordance with claim 13, wherein the step of utilizing the previously used network entity to connect with the mobile unit without querying for an updated network entity associated with the mobile unit comprises utilizing the MSC to connect with the mobile unit without querying a Home Subscriber Server (HSS).

15. A method for connecting to a mobile unit in accordance with claim 13, wherein the step of utilizing the previously used network entity to connect with the mobile unit without querying for an updated network entity associated with the mobile unit comprises utilizing the MSC to connect with the mobile unit without querying a Home Location Register (HLR).
